(19) United States
(12) Patent Application Publication
(10) Pub. No.: US 2013/0088363 A1
(43) Pub. Date: Apr. 11, 2013

(54) Telemetry Method and System for Well Logging

(71) Applicant: Alexander Gonzalez, Valle del Cauca (CO)

(72) Inventor: Alexander Gonzalez, Valle del Cauca (CO)

(21) Appl. No.: 13/267,313

(22) Filed: Oct. 6, 2011

(51) Int. Cl. G01V 3/00

(52) U.S. Cl. 340/854.9

(57) ABSTRACT

A telemetry system using four-level positive pulses is provided to transmit data over a logging cable. More particularly, method and apparatus are provided for using multi-level positive pulses that may have variable width for communication from up hole to down hole, self-clocking modulation and a synchronization circuit to obtain more efficient downlinks and transmission of data to the surface via electric wireline. A peak detector circuit avoids the requirement for very high-speed analog-to-digital converters and a synchronization circuit allows knowing when a pulse is ready to be processed, thus reducing the requirements for processing.

### BACKGROUND OF INVENTION

1. Field of the Invention

This invention relates to bi-directional telemetry for use in logging of wells.

2. Description of Related Art

Logging of wells provides a continuous record vs. depth of physical measurements that are used to predict properties of rock surrounding a wellbore and properties of the fluids contained in pores of the rock. Electrical resistivity, bulk density, natural and induced radioactivity, acoustical properties, nuclear and other measurements may be made. A continuous record versus depth of formation properties, such as rock porosity and lithology, and fluid type and saturation may be derived.

The logging procedure includes lowering a logging tool on an electric wireline into a well. Data are usually recorded as the logging tool is pulled out of the hole. The data are recorded electronically or on a printed record called a “well log” and are normally transmitted digitally to office locations. Well logging may be performed at various intervals during the drilling of a well and when the total depth is reached. The length of electric wireline used in a typical well may vary from 1000 m (3000 ft) to 10000 m (30000 ft) or more. Telemetry systems and methods for logging are thus used over a wide range of pressure and temperature conditions. There is need to adjust a telemetry system as wireline conditions change.

U.S. Pat. App. Pub. No. 2010/0073190 discloses a method and system for transmitting data over a plurality of transmission channels, each channel having a range of frequencies. At least one channel uses carrierless phase-amplitude (CAP) modulation. U.S. Pat. No. 5,331,318 discloses a communications protocol for a digital telemetry system that enables more efficient digital data transmission between a plurality of digital communications nodes. The protocol is implemented using uplink and downlink packets and superpackets.

There is need to transmit data from the downhole logging instruments available today in industry with greater accuracy, higher data rate and lower cost, New methods and apparatus are needed to provide an improved communication bridge between the tools downhole and a computer at the surface.

### SUMMARY OF THE INVENTION

Apparatus and method are provided for telemetry of signals from well logging tools using positive voltage pulses. Uphole and downhole telemetry boards communicate with a computer and logging tools using USB and 12C protocols, respectively. The boards can be controlled to change equalization conditions and pulse width to account for line changes. Signals are sent from the downhole board when data are to be transmitted. By detecting the rising edge of pulses, the receiver can adjust its clock to the clock in the transmitter.

### BRIEF DESCRIPTION OF THE SEVERAL VIEWS OF THE DRAWING(S)

FIG. 1 is a basic diagram of a telemetry system containing N tools.

FIG. 2 shows the structure for the computer sending commands to the telemetry.

FIG. 3 shows a description for each one of the fields.

FIG. 4 shows the commands processed by the telemetry.

FIG. 5 illustrates the structure of the information from the downhole to the uphole telemetry.

FIG. 6 describes the last bytes in the frame transmitted from down hole to up hole.

FIG. 7 shows the description of the last bytes of the frame.

FIG. 8 shows the general diagram of the two electronic boards used in the telemetry system.

FIG. 9 shows the description of the command functional blocks.

FIG. 10 shows the block diagram for the uphole telemetry board.

FIG. 11 illustrates uphole telemetry signals. The voltage scale is 500 mV/div.

FIG. 12 is a block diagram for the downhole telemetry board.

FIGS. 13(a) and 13(b) illustrate downhole telemetry signals. The scale is 1 V/div.

FIG. 14 shows the uphole telemetry flowchart for autoequalization.

FIG. 15 shows the uphole telemetry flowchart for the configuration mode.

FIG. 16 shows the flowchart for the downhole equalization process,

FIG. 17 shows the uphole telemetry flowchart for the logging mode.

FIG. 18 shows the uphole telemetry flowchart for the debug mode.

FIG. 19 shows the downhole telemetry flowchart for the debug mode.

FIG. 20 shows the downhole telemetry flowchart for the togging mode.

FIG. 21 shows the downhole telemetry flowchart for the configuration mode.

FIG. 22 shows the flowchart for the autoequalization process downhole.

FIG. 23 shows an overall diagram of the logging system.

### DETAILED DESCRIPTION OF THE INVENTION

The telemetry system disclosed herein provides a communication bridge between tools downhole and a computer uphole. The system includes two boards—a downhole telemetry board, which communicates with the tools using 12C, and an uphole telemetry board, which communicates with a computer using USB. The telemetry boards communicate with each other through a logging cable, using positive multilevel signaling and differential signals. The use of four-level positive pulses, instead of positive and negative pulses, helps to reduce offset problems. The information from uphole to downhole travels at 2K symbol/sec whereas the information from downhole to uphole travels at 100 K symbol/sec (one symbol is two bits).

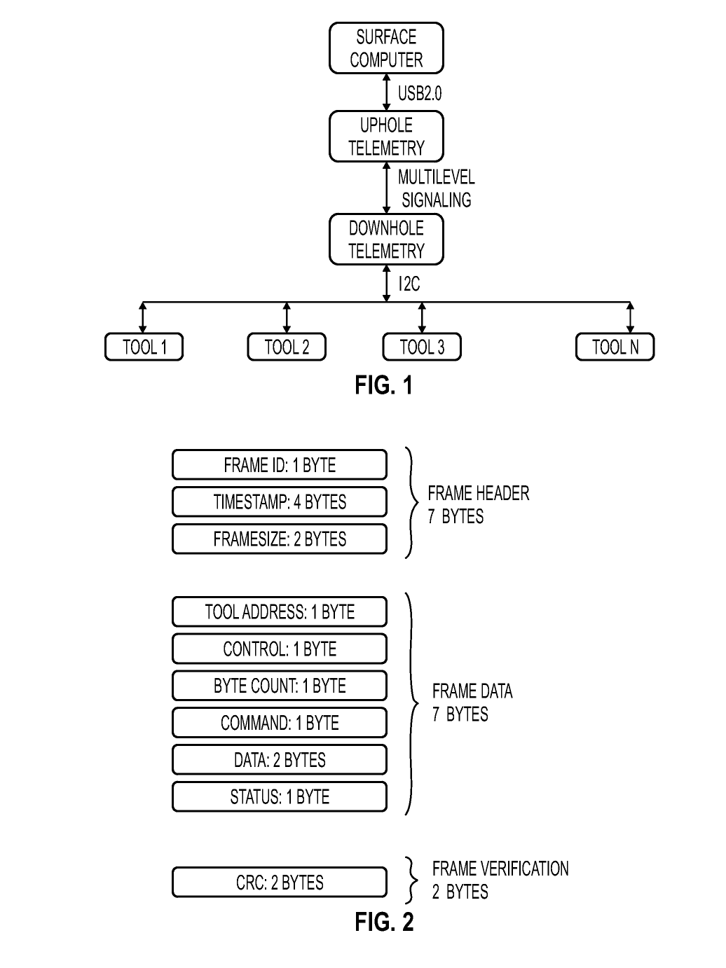

The information in the telemetry is organized in packets and frames. A packet is a unit with information from only one tool, The packet structure indicates the tool, the command executed by the tool, the number of bytes it is sending and the data sent by the tool. A frame is a group of packets transmitted continuously during a period of time. A basic diagram of the telemetry system is shown in FIG. 1.

The telemetry has four operating modes: (1) Power-Up Mode. Performs set-up and auto-equalization tasks. This mode is executed automatically as soon as the boards are powered up. (2) Configuration Mode. In this mode commands from the computer are accepted. (3) Debug Mode. This mode is used to know if the equalizer is properly adjusted. If so, an 8 bit counter (ascending from 0 to 255 and rolling over) must be received. (4) Logging Mode. This mode is used to acquire information from the tools in a real operation.

Surface communication uses the USB 2.0 protocol between the telemetry uphole board and a computer. The information is exchanged in frames. There are two formats for the frames—one for the information from the computer to the telemetry and the other for information from the telemetry to the computer.

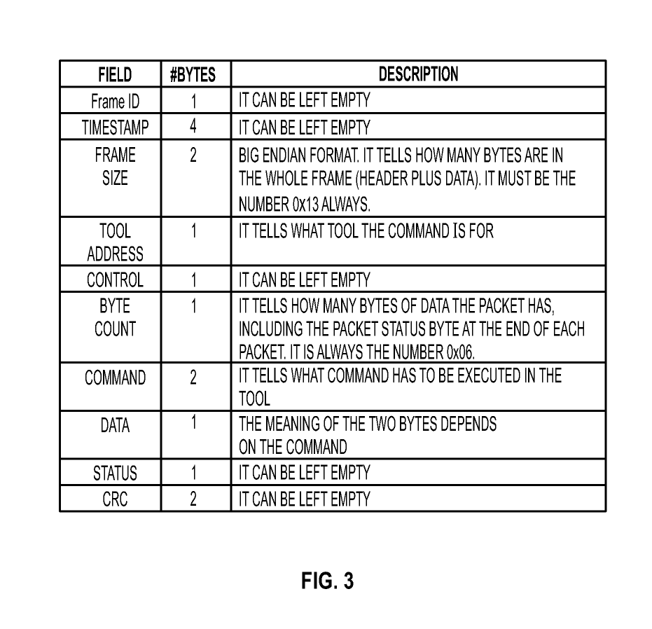

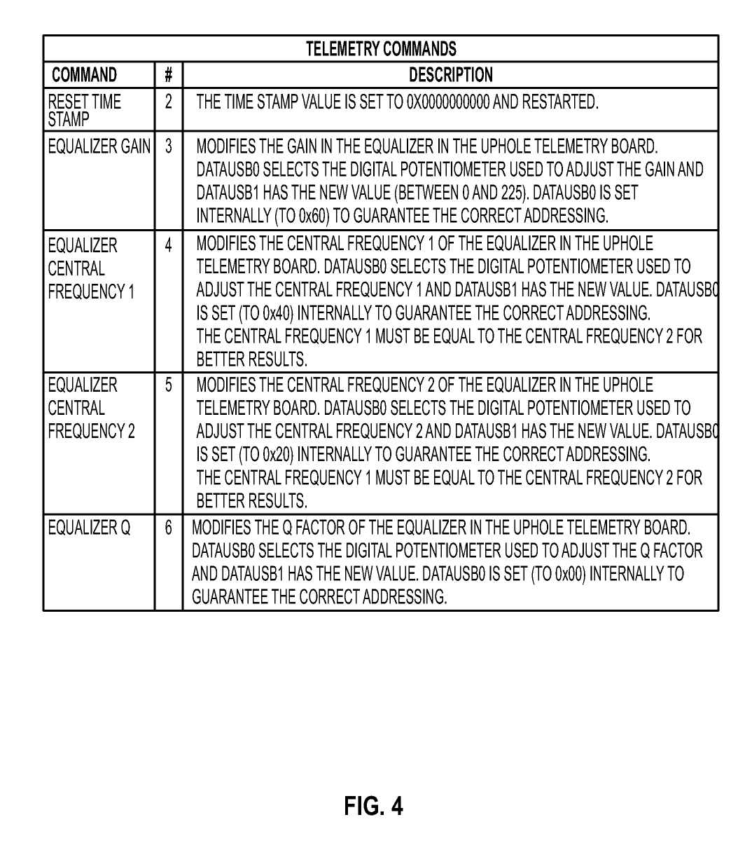

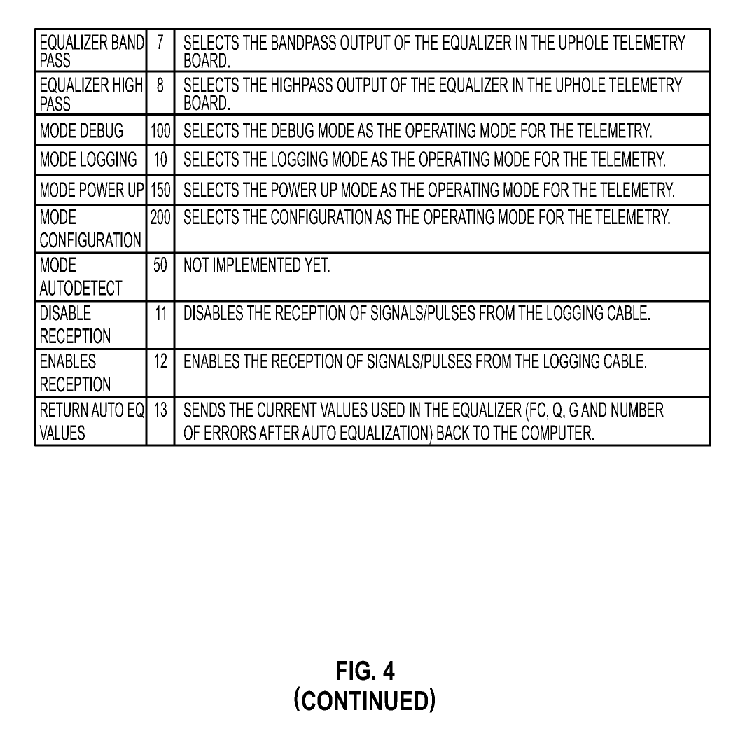

The computer sends commands to the telemetry using the structure shown in FIG. 2. The description for each one of the fields is shown in FIG. 3. The commands sent by the computer to the telemetry can be processed by the telemetry itself or executed by a tool. The commands processed by the telemetry are shown in FIG. 4.

The commands for the tools will normally be available in the manual of each tool and can be taken from there or another source provided with the tool.

The telemetry sends to the computer the data read from the tools or answers to commands requesting information about the initial setup of the telemetry itself. The information is organized in frames. Basically, a frame is defined based on the maximum time that the downhole telemetry is allowed transmitting data continuously.

Every time that a tool is read, its information is organized in a packet. The packet indicates the tool the data belongs to, the command the tool answered to and the number of bytes of data that the tool returned. The packets are generated when the tools are read in the debug or logging mode and stored in the internal FIFO of the telemetry until it is time to transmit the information. When the packets are going to be transmitted, they are organized in frames. The frame groups the packets and adds control information at the end of the frame to validate the information. The last packet is always a packet for validation. If the frame has no data from the tools, then the frame has just one packet—the validation packet.

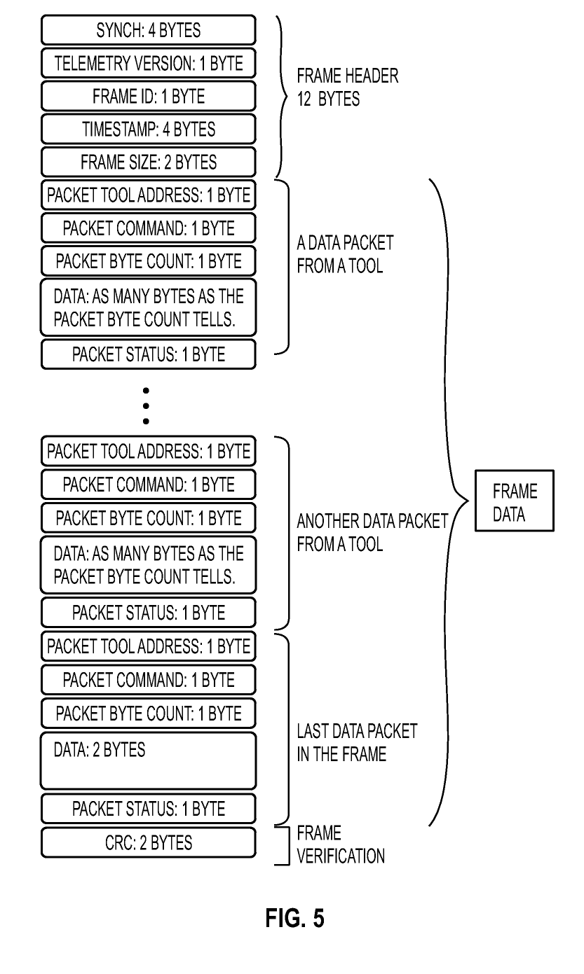

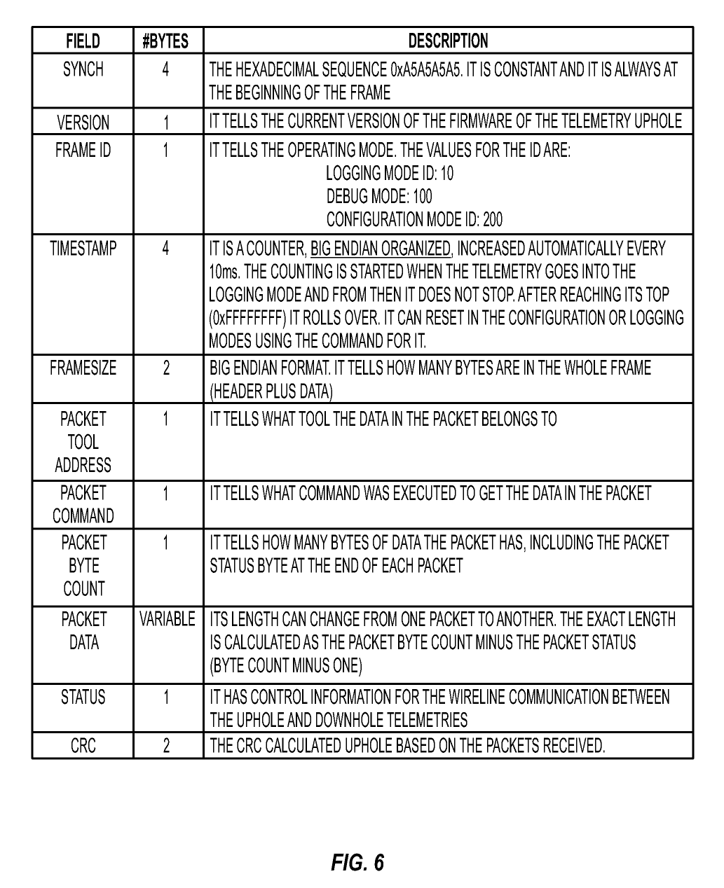

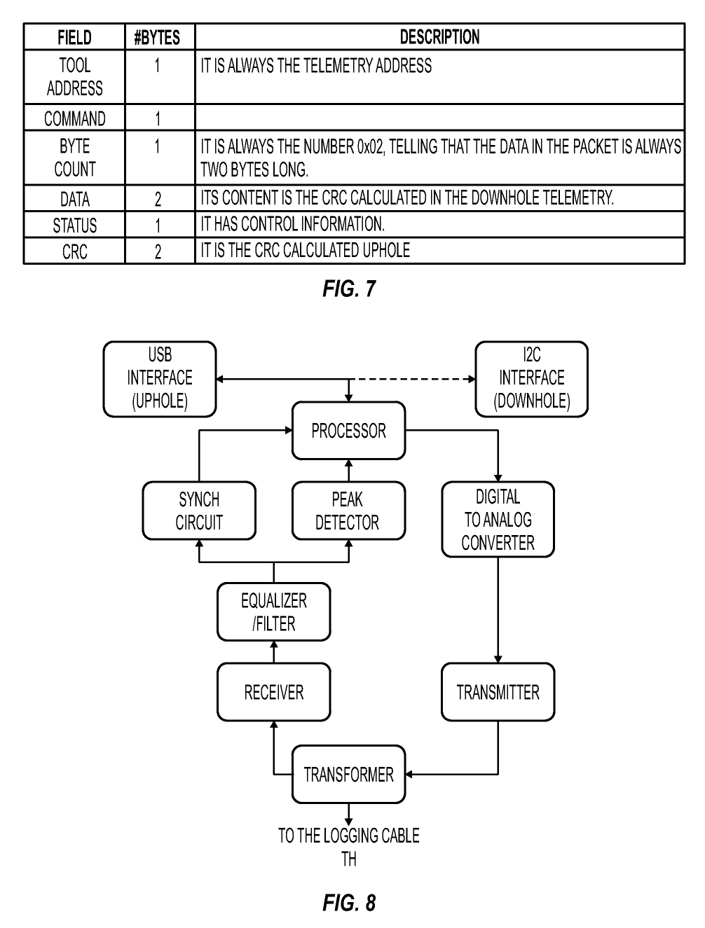

The information is organized following the structure shown in FIG. 5. The description of the fields is shown in FIG. 6. The last part in the frame is always a control packet followed by two bytes of the CRC (Cyclic Redundancy Check). If the CRC calculated uphole matches the CRC calculated downhole, this means that there are no errors in the reception of the frame. The description of the last bytes of the frame is shown in FIG. 7.

The line communication refers to the communication between the telemetry boards, uphole and downhole. In this case, differential, multilevel signaling is preferably used. Besides the difference in the amplitudes, there is a difference between the data pulses and synchronization pulses. Synchronization pulses are longer than data pulses and they are transmitted with each byte. The exchange of information between the telemetries uphole and downhole is done in packets. A packet, as mentioned earlier, has the structure shown in FIG. 5.

The uphole telemetry controls the synchronization of the system. In one embodiment, the uphole telemetry sends one command to the downhole telemetry in about 28 ms per period, every period, and then waits about 34 ms to receive data from the downhole telemetry. Down hole always waits for a command from up hole. The total time for a frame is thus about 62 ms. The system uses a self-clocking modulation. By detecting the rising edge of each pulse, the receiver can adjust its own clock to the one in the transmitter. The rising edge is detected by a voltage comparator.

Down hole communication between the downhole telemetry board and the tools uses 12C protocol. When data are going to be read from the tool, the structure shown in FIG. 5 is followed:

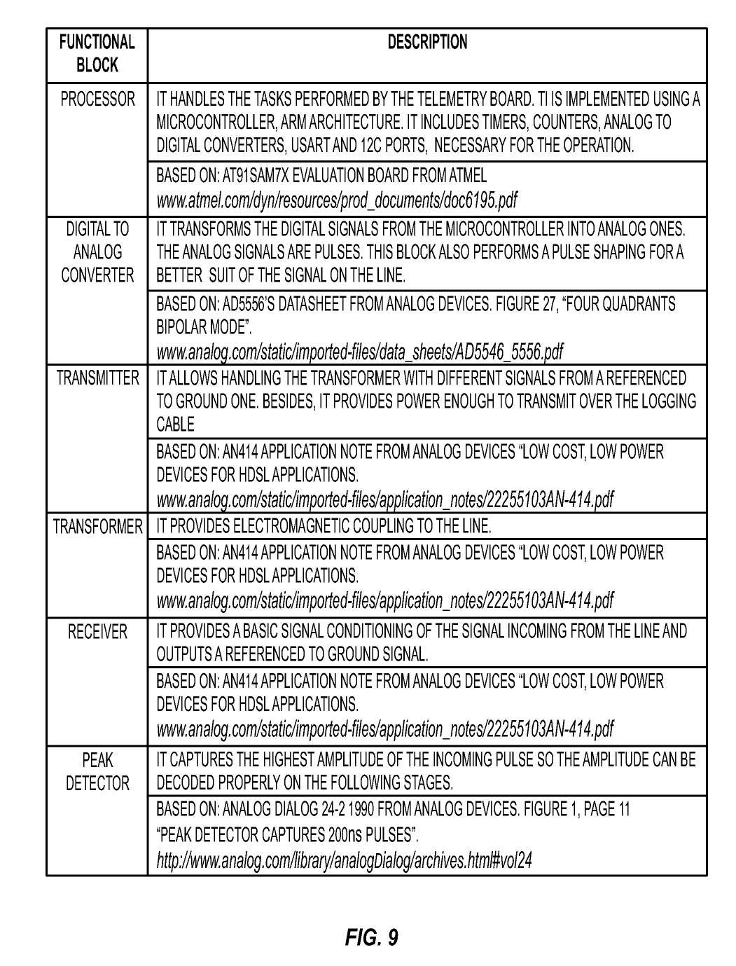

The telemetry system includes two electronic boards: one for the uphole telemetry and one for the downhole telemetry. These boards were designed such that their internal circuits were as similar as possible in order to ease their construction and debugging. Each board can be divided into functional circuits, as shown in FIG. 8. The functional blocks shown are the same in both boards except the two different interface blocks at the top, which are specific for each board. The telemetry boards are like bridges between two different communication protocols—for the uphole board it is USB2.0 and for the downhole board it is 12C, The description of the common functional blocks and their basis are shown in FIG. 9.

The computer communicates with the telemetry uphole board via the USB2.0 protocol. On the line side, it performs half duplex communication protocol designed for the application specifically. When it transmits data, it does it at 2K symbol/sec (one symbols is two bits), using multilevel signaling (four levels). When it receives data, it receives at about 43.5 ksymbols/sec, again using four-level signals.

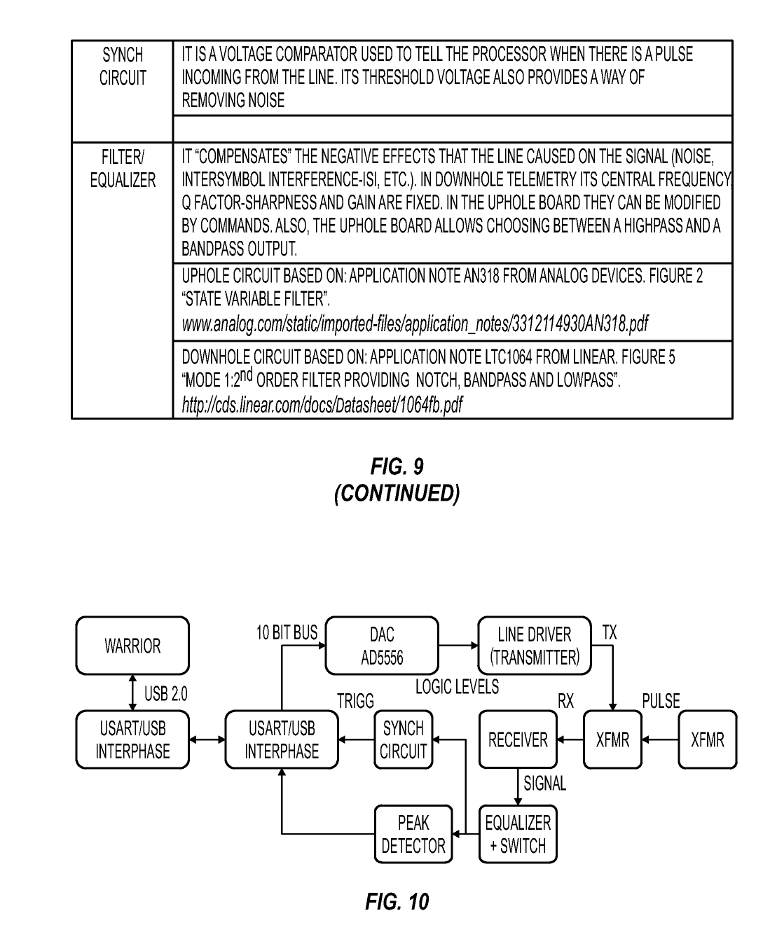

It can be noticed that the transmission and reception are at different speeds. Before decoding the signals incoming from the line, they need to be equalized due to noise, Inter-symbol Interference (ISI) and other effects caused by the line. The uphole telemetry board implements a hardware equalizer that allows modifying at anytime the central frequency, Q-factor (sharpness) and gain in order to compensate for line effects. Also, a highpass or bandpass output of the equalizer can be chosen. A block diagram for the uphole telemetry board is shown in FIG. 10.

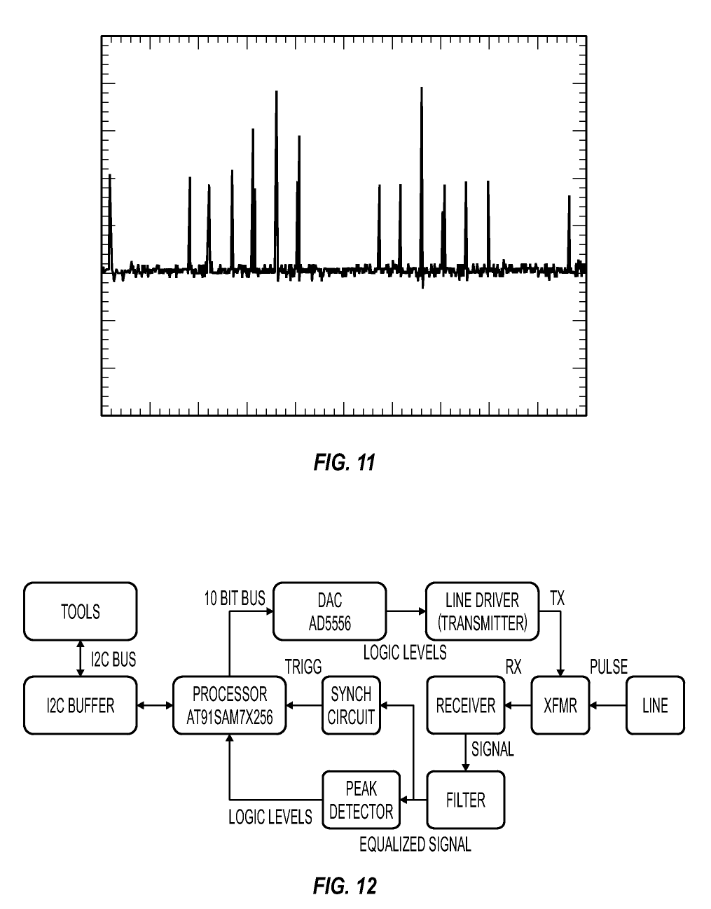

Although the processor has the capacity of implementing a USB connection, this task is preferably performed by a different IC in order to avoid processing overhead. This IC may be a USB—USART Bridge, which takes care of the USB interface. On its USART side, it behaves as an 8 bit, asynchronus, no parity, 460800 bps USART. On its USB side, it is a USB2.0 device. An example of an uphole telemetry signal is shown in FIG. 11. The signal was obtained at test point 1 uphole, at the output of the DAC. The amplitudes of the pulses are: 1.08 V, 1.52 V, 2.0 V and 2.48 V. The time between data pulses is 520 [symbol] s.

The downhole telemetry board is a communication bridge between the uphole telemetry board and the tools downhole. On the line side, it performs half duplex communication protocol designed for the application specifically. When it transmits data, it does so at about 43.5 ksymbol/sec, using multilevel signaling. When it receives data, it receives at 2K symbols/sec.

Before decoding the signals incoming from the line, the signals are equalized, due to noise, Inter-Symbol Interference (ISI) and other effects caused by the line. The downhole telemetry board implements a hardware equalizer (filter) as in the uphole board. The central frequency, Q-factor (sharpness) and gain can be modified to compensate for line effects. A block diagram for the downhole telemetry board is shown in FIG. 12. The particular functional block of this board is related to the 12C buffer. It amplifies the 12C signals handled by the processor; therefore, a longer distance can be reached. The “synch circuit,” in response to a signal from the surface, triggers the downhole processor of signals from the tools. The components of the circuit include the peak detector and voltage comparator. The peak detector avoids the requirement for very high-speed ADCs, since it makes the amplitude of the pulse constant as long as needed for sampling. The synch circuit allows knowing when there are data to be processed. This reduces the amount of processing at the receiver. Other systems need to keep sampling all the time and process all the samples in order to determine whether there are data, to recover envelopes, or for other purposes, even if no data are transmitted.

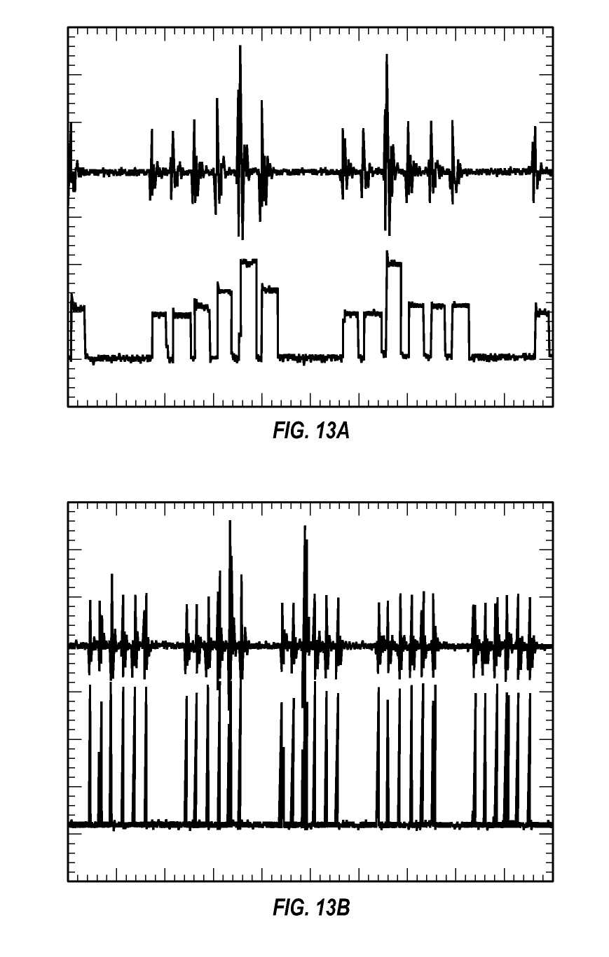

Examples of downhole telemetry signals are shown in FIGS, 13(a) and 13(b). In FIG. 13(a), the signal from Test Point 5, the output of the filter, is shown in the top curve and the signal from the peak detector (Test Point 6) is shown in the bottom curve. The scale is 2V/Div. In FIG. 13(b), the bottom curve shows the output of the filter and the top curve shows the output of the comparator or “synch circuit” in FIG. 12.

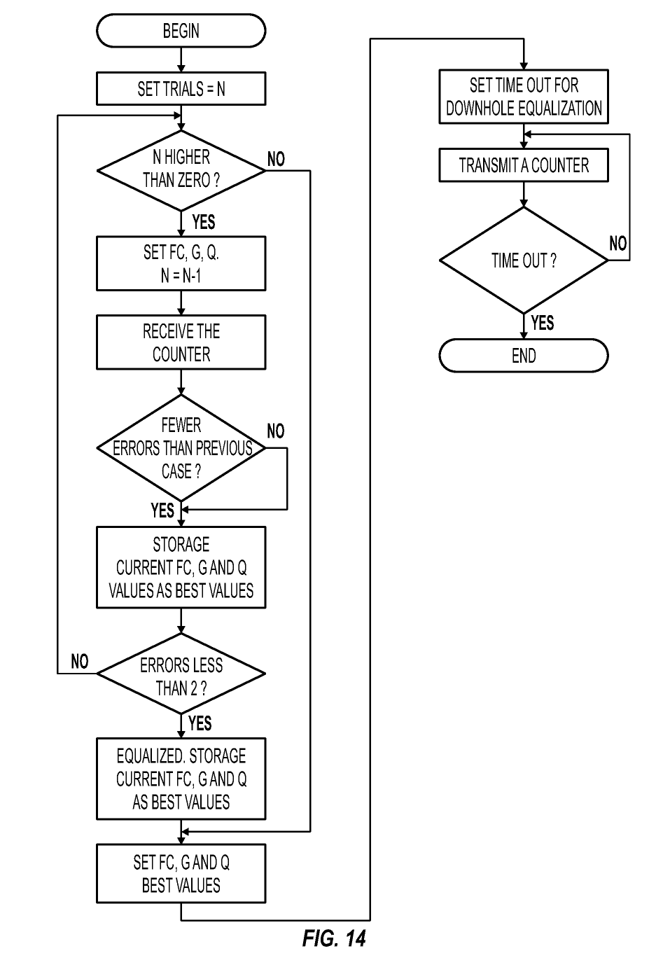

Flowcharts for uphole telemetry are shown in FIGS. 14-17. FIG. 14 is the flowchart for the autoequalization function. For the autoequalization process, the downhole telemetry board sends continuously a counter and waits for some time for an uphole answer. If there is an answer, it means the autoequalization was achieved. Meanwhile, the uphole telemetry board receives the signals from down hole, decodes and tries to identify a counter in the received sequence. If the sequence is fine, it answers back to the telemetry down hole. If the sequence has errors, the uphole telemetry does not answer. The system uses a self-clocking modulation, By detecting the rising edge of each pulse, the receiver can adjust its own dock to the one in the transmitter. The rising edge is detected by a voltage comparator.

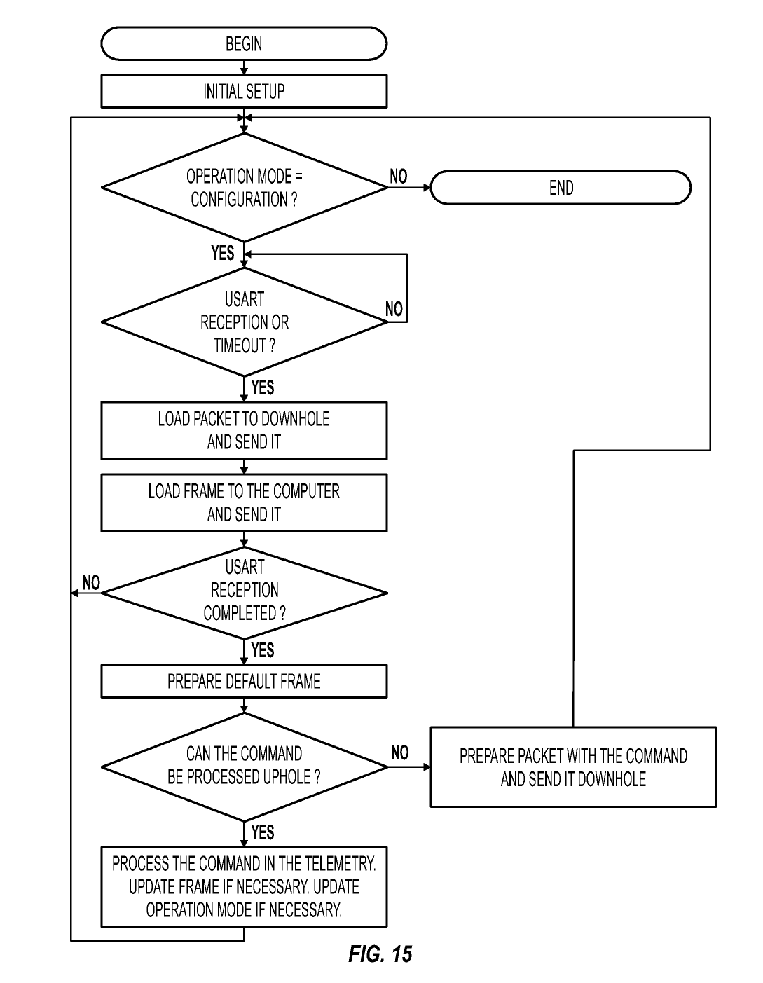

FIG. 15 is the flowchart for the configuration mode. For the configuration mode, the uphole telemetry board checks whether there is a command from the computer or not. If there is, it checks if the command can be executed in the telemetry itself or if it needs to be sent down hole to be executed. Steps are shown in the figure.

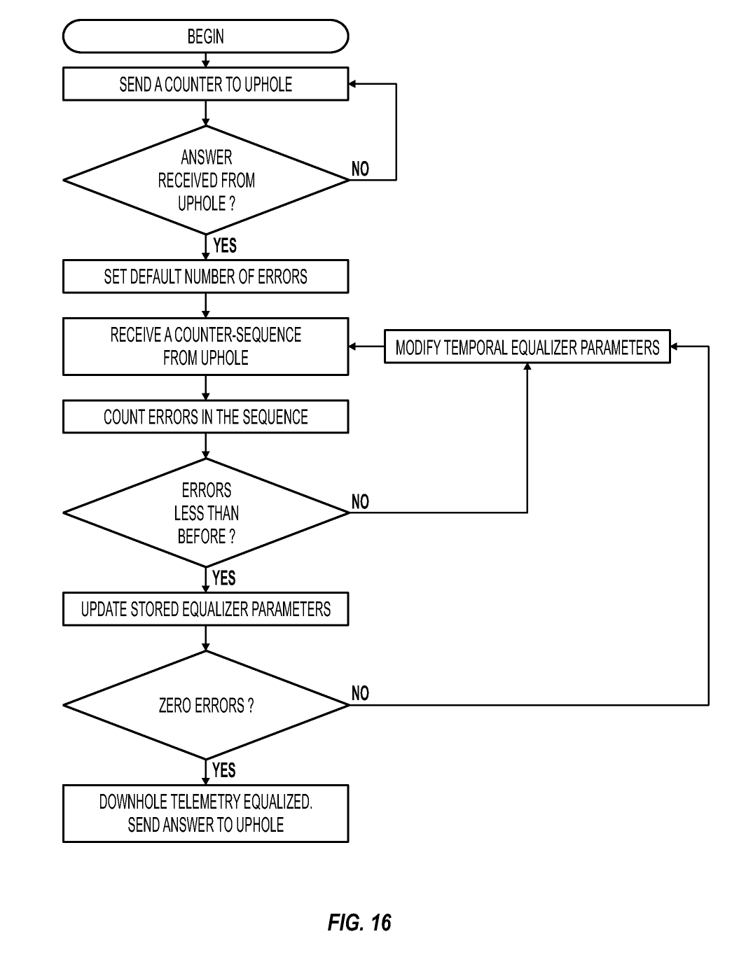

FIG. 16 is the flowchart for the downhole equalization process. The process starts with the downhole telemetry transmitting a counter to the uphole telemetry. After a counter is transmitted, downhole checks to determine if uphole answered. If so, it means that uphole telemetry is equalized and then the equalization process for the downhole telemetry is started. If there is no answer, the downhole telemetry transmits a counter again. In order to get downhole equalized, the uphole transmits a counter, the downhole telemetry receives the sequence and checks whether there is an error. If there is an error, the parameters of the equalizer downhole telemetry are modified and a new sequence of data transmitted from uphole is processed. When the sequence is received without an error or errors, the downhole telemetry equalizer has been adjusted properly,

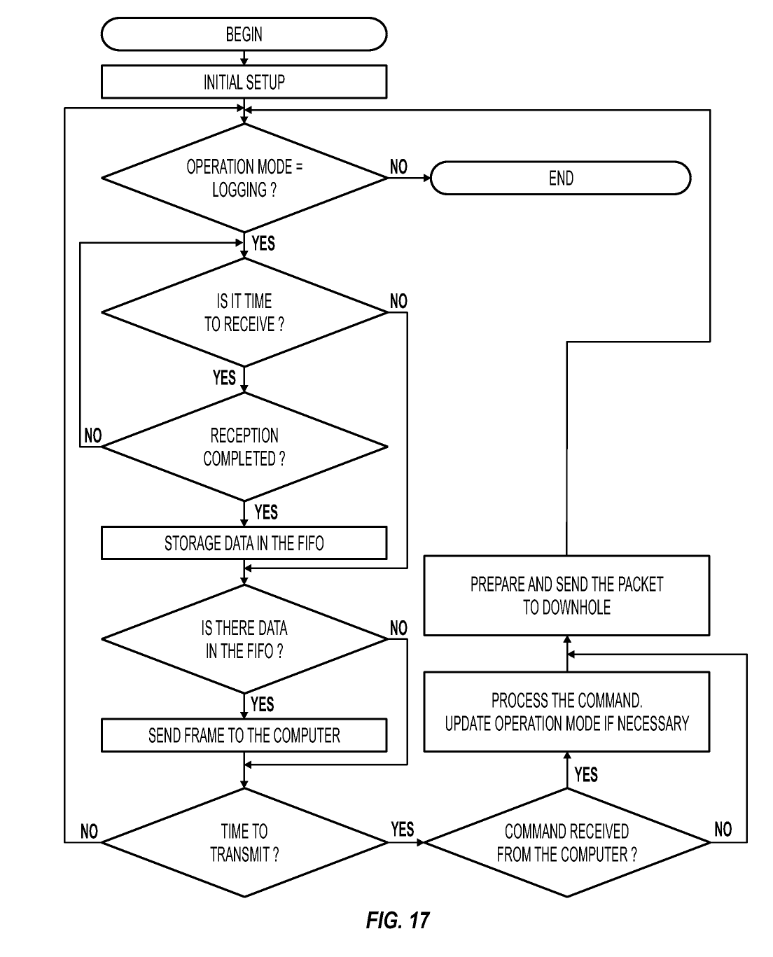

FIG. 17 is the flowchart for the logging mode. For the logging mode, the uphole telemetry waits for some time to receive data from the downhole telemetry and then it packs the data and sends it to the computer.

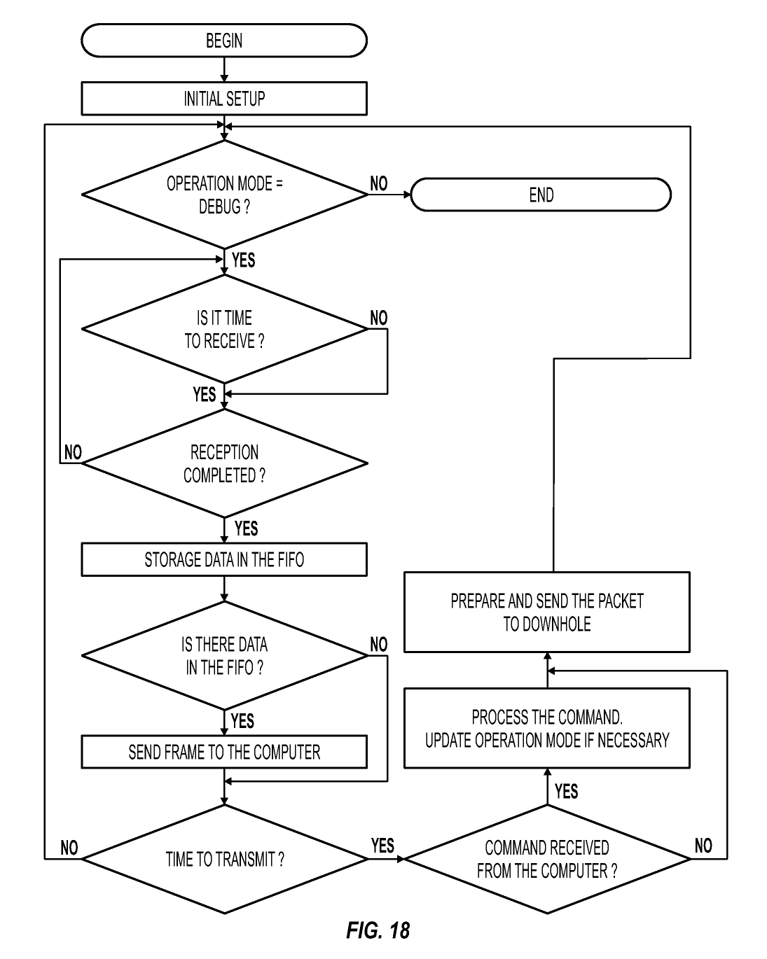

FIG. 18 is the flowchart for the debug mode. For the debug mode, the telemetry up hole performs the same tasks as in the logging mode.

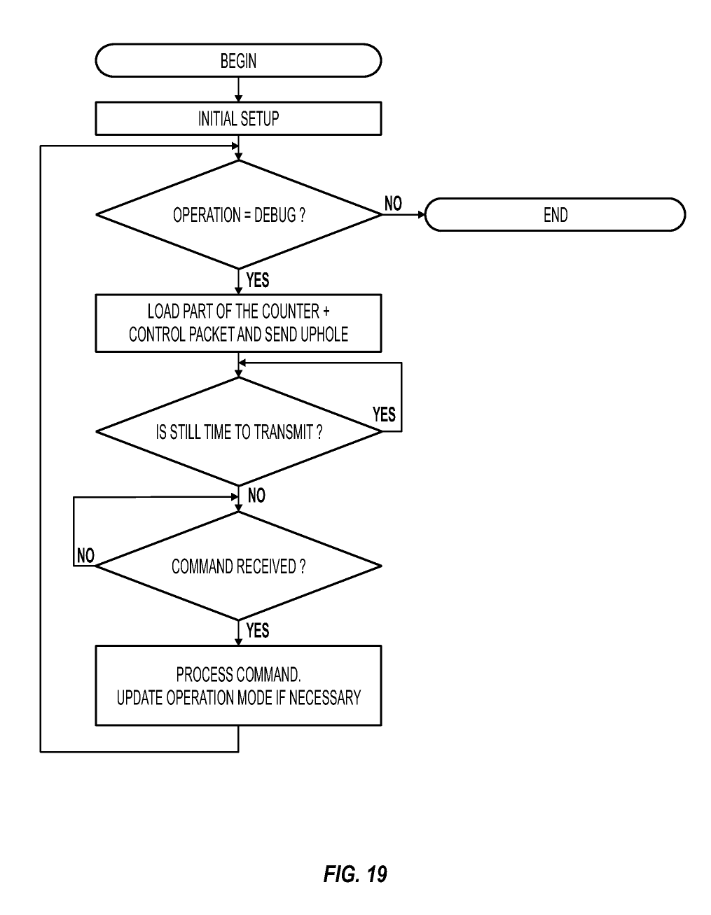

Flowcharts for downhole telemetry are shown in FIGS. 19-22. FIG. 19 is the flowchart for the debug function. For the debug mode down hole, the downhole telemetry sends part of a counter while it is allowed to transmit, then waits for a command from the uphole telemetry in order to know whether it is necessary to stay in the same operating mode or not.

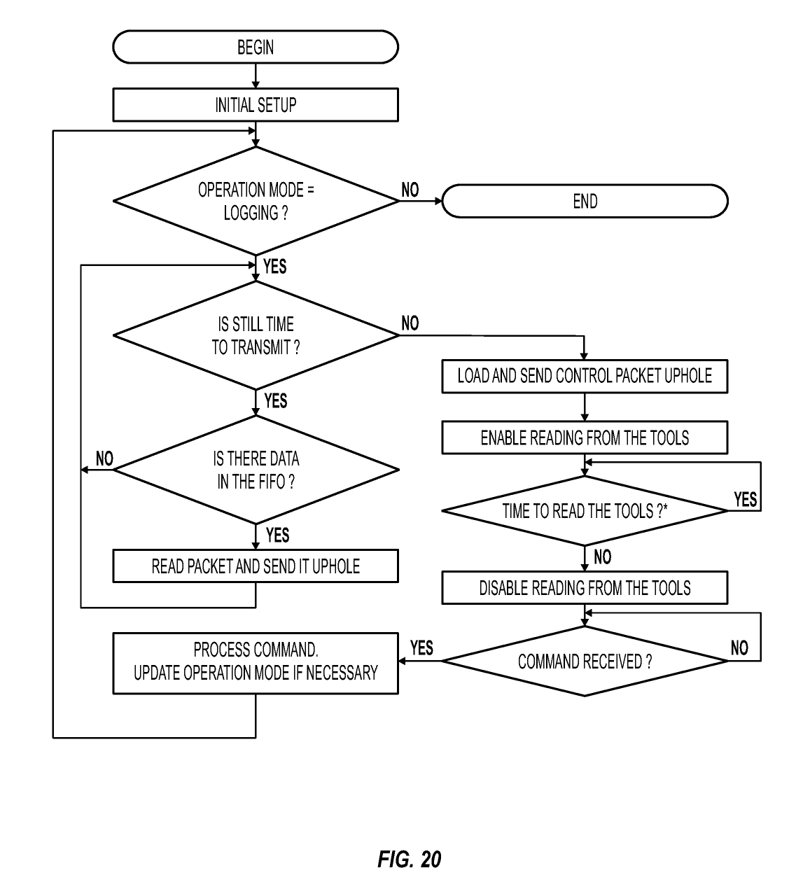

FIG. 20 is the flowchart for the logging mode. For the logging mode down hole, the down hole sends the information in its internal memory while it is time to transmit, then reads data from the enabled tools and then waits for a command from the uphole telemetry in order to know whether it is necessary to stay in the same operating mode or not.

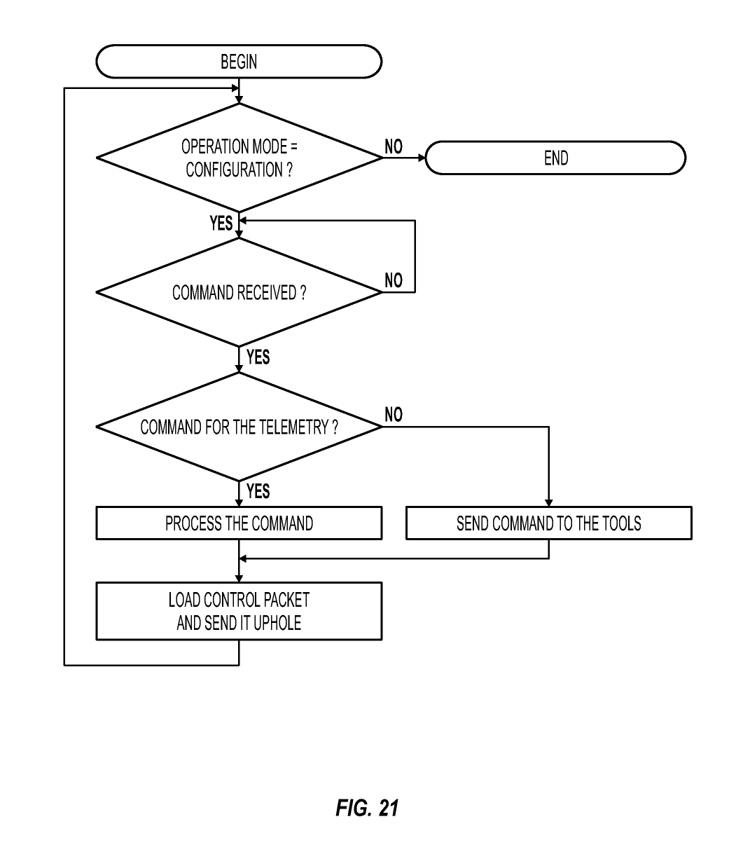

FIG. 21 is the flowchart for the configuration mode, For the configuration mode down hole, the telemetry downhole waits for a command from the up hole and when it receives it, decodes it to know whether the command is for itself or the tools. If the command is for the telemetry, it executes the command. If the command is for the tools, it sends the command to the tools.

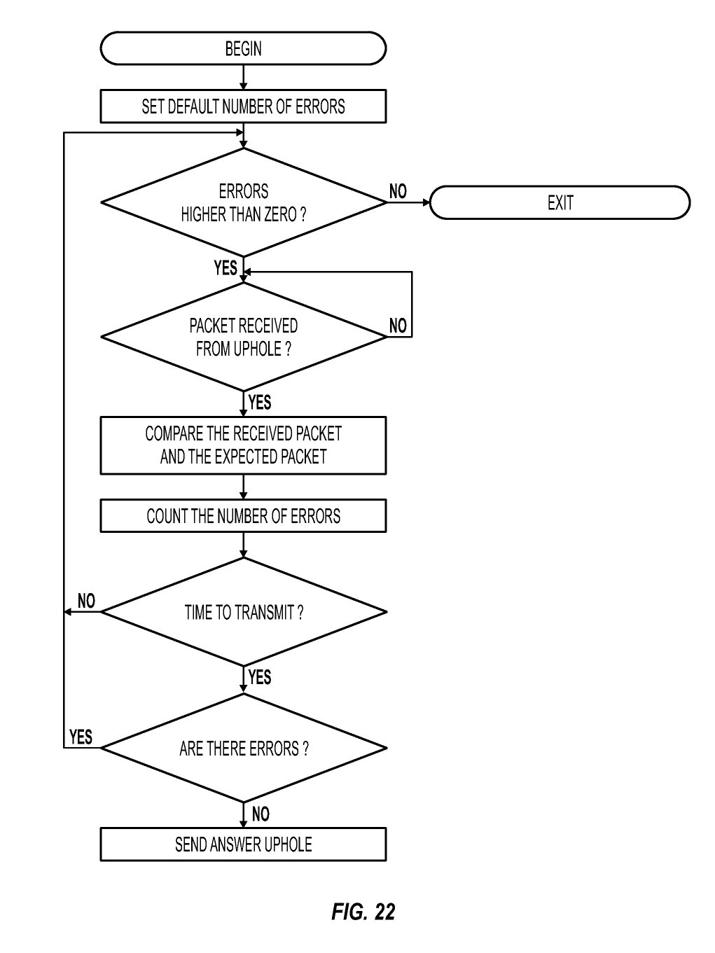

FIG. 22 is the flowchart for the autoequalization process downhole.

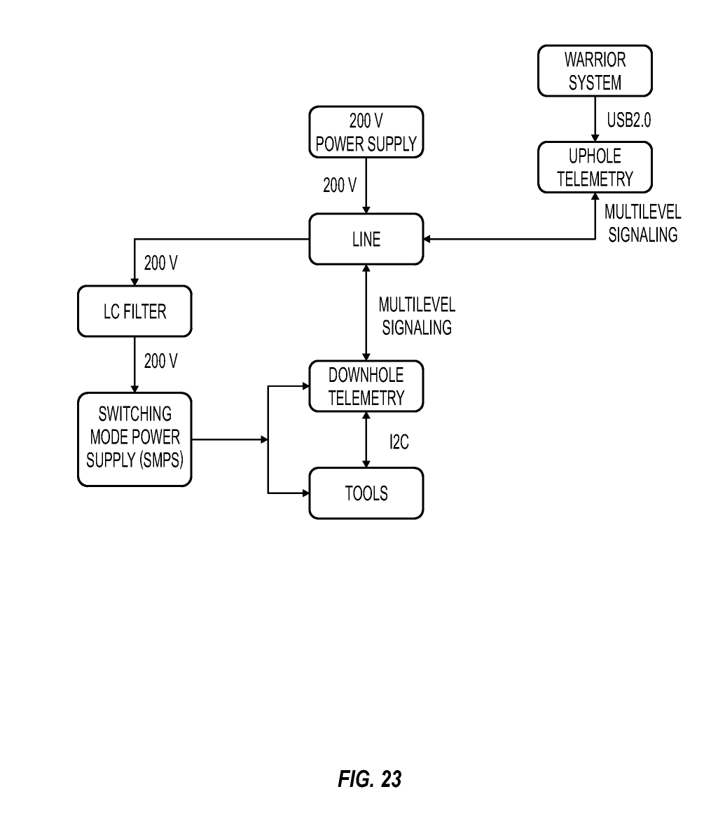

FIG. 23 shows a diagram of one embodiment of a logging system employing multilevel signaling. The power supply to the line may be 200 V. A switching mode power supply may provide power to the downhole telemetry and tools, “Warrior system” is the trade name for the surface equipment.

### EXAMPLE

### Debug Mode

In debug mode, the information received by the computer can be divided in four parts. The first part is the header, in which fields are Synch, Version, USB ID, TimeStamp and Frame Size. its length is always 12 bytes. The synch is four bytes, always the number 0×A5 (165d). Version 002, for example, means the second version of the telemetry. USB ID: 100 means, for example, that the telemetry is in the Debug Mode, Time Stamp: 000 000 025 114, for example, has the value of the counter when the frame was sent. Frame Size: 000 034, for example, means that the number of bytes in the whole frame is 34.

Next is the data of the frame, organized in packets. The fields of a packet are Tool Address (tool that generates the data in the packet), Command (command executed to generate that data), Byte Count (Number of bytes of data in the packet), and Data and Status (control information between the telemetries up hole and down hole). Tool Address: 001, for example, means that the data belong to the telemetry. Command H: 100, for example, means that the data were generated after executing the Debug command. Byte count: 010, for example, means that 10 bytes of data were generated. The procedure described above may be continued to complete the transmission.

It is understood that modifications to the invention may be made as might occur to one skilled in the field of the invention within the scope of the appended claims. All embodiments contemplated hereunder which achieve the objects of the invention have not been shown in complete detail. Other embodiments may be developed without departing from the spirit of the invention or from the scope of the appended claims. Although the present invention has been described with respect to specific details, it is not intended that such details should be regarded as limitations on the scope of the invention, except to the extent that they are included in the accompanying claims.

I claim:

1. A telemetry system for logging of wells, comprising:
a surface computer;
a downhole telemetry electronic board and an uphole telemetry electronic board, wherein the telemetry boards include means for communicating with each other through a line or cable using multi-level pulses for signaling; and
a link to a downhole tool,

2. The telemetry system of claim 1 wherein the uphole board includes means for communicating with a computer using USB protocol and the downhole board includes means for communicating with the tool using 12C protocol.

3. The telemetry system of claim 1 wherein the uphole board and the downhole board comprise a processor, a digital to analog converter, a transmitter, a transformer, a receiver, a peak detector, a synchronization circuit and an equalizer.

4. The telemetry system of claim 3 wherein the synchronization circuit comprises a peak detector and a voltage comparator.

5. The telemetry system of claim 3 wherein the central frequency and Q-factor of the equalizer and gain of the uphole board can be modified by commands so as to compensate for line effects.

6. The telemetry system of claim 1 wherein the telemetry boards further are connected so as to communicate using differential signaling.

7. The telemetry system of claim 3 wherein the synchronization circuit includes means for triggering the downhole processor to send a signal from the tool.

8. The telemetry system of claim 4 wherein the voltage comparator is used to detect arising edge of the pulses.

9. A method for communicating with and receiving data from a logging tool, comprising:
providing a computer, an uphole telemetry electronic board adapted to communicate with the computer, a downhole telemetry electronic board adapted to communicate with the logging tool and an electric line connecting the uphole and downhole electronic boards;
forming multilevel pulses and sending commands from the computer to the uphole telemetry electronic board and the logging tool using the pulses; and
receiving a signal from the logging tool in multilevel pulses.

10. The method of claim 9 further comprising adjusting the width of pulses from the uphole telemetry electronic board to the logging tool.

11. The method of claim 9 further comprising detecting the rising edge of each pulse.

12. The method of claim 9 further comprising determining when data in the downhole telemetry board are to be processed.

13. The method of claim 9 further comprising applying a filter to equalize the received signal.
